(19) United States
(12) Patent Application Publication
(10) Pub. No.: US 2016/0099084 A1
(43) Pub. Date: Apr. 7, 2016

(54) METHOD OF PLATINUM INJECTION INTO A NUCLEAR REACTOR

(71) Applicant: AREVA Inc., Lynchburg, VA (US)

(72) Inventors: John M. Riddle, Forest, VA (US); Mihai G. M. Pop, Alexandria, VA (US); Larry S. Lamanna, Amherst, VA (US)

(21) Appl. No.: 14/505,410

(22) Filed: Oct. 2, 2014

(51) Int. Cl. G21C 15/18; G21C 3/07; G05B 13/04; G21C 1/08

(52) U.S. Cl. CPC G21C 15/18; G21C 1/084; G21C 3/07; G05B 13/041

(57) ABSTRACT

A method of injecting platinum into a Boiling Water Reactor is provided. The Boiling Water Reactor includes a reactor core including a plurality of fuel rods having a zirconium alloy cladding. The method includes injecting a first platinate compound and a second platinate compound into a nuclear reactor. The first platinate compound is non-alkalizing and the second platinate compound includes an alkalizing element. The first platinate compound and the second platinate compound are injected such that the second platinate compound injected does not exceed a predetermined threshold or such that a value related to an alkalizing element of the second platinate compound does not exceed a predetermined threshold.

The present disclosure relates generally to nuclear reactors and more specifically to a method of injecting platinum compounds into nuclear reactors.

### BACKGROUND

During operation of a fuel assembly in a nuclear reactor, the function of fuel rods is to allow transmission of heat resulting from the fission reaction inside fuel pellets mounted in the fuel rods, while providing cladding to separate radioactive fuel pin material of the fuel pellets from streaming cooling fluid, which in light water reactors consists of water. During operation the fuel rods are subjected to heat, irradiation from the fuel pellets and a chemical reactive environment from the streaming medium.

The cladding of fuel rods in light water reactors are usually manufactured from a zirconium alloy. Zirconium is used in fuel rods due to its suitable mechanical properties, low neutron cross section, and a relatively high corrosion resistance. Different types of zirconium alloys are available for different types of light water reactors.

In spite of the favorable properties of the zirconium alloys, fuel rods manufactured from a zirconium alloy are affected by the environment in the reactor (heat, radioactivity and chemistry environment, amount of deposition and location of deposition on the cladding of the fuel rods). Depositions on the cladding of fuel rods contain various species, depending on the chemistry of water circulating inside the reactor core. The environment in the reactor is known to result in intergranular stress corrosion cracking (“IGSCC”) at the surfaces of the cladding of the fuel rods.

In order to prevent or minimize IGSCC, it has been known to inject hydrogen into the reactor feedwater to reduce the oxidizing power inside the reactor. A further technique was also established of continuously injecting a small amount of hydrogen plus occasional batch injection of noble metals during plant shutdown, when the temperature is approximately 260° F. The noble metals may catalyze the recombination of oxygen and hydrogen peroxide with hydrogen. GE-Hitachi Nuclear Energy, in process known as ON-LINE NOBLECHEM (“OLNC”), also provides a platinum solution for injection into a Boiling Water Reactor (“BWR”) during while the plant is operating at or near full power, when the temperature is approximately 530° F.

U.S. Pat. No. 5,818,893, which is assigned to General Electric Company, discloses doping oxidized stainless steel surfaces with low concentrations of one more metals by injecting compounds a point downstream of a recirculation water outlet. The metals are stated as being compounds of “platinum group metals” (i.e., platinum, palladium, osmium, ruthenium, iridium, rhodium and mixtures thereof), compounds of “non-platinum group metals” (i.e., zinc, titanium, zirconium, niobium, tantalum, tungsten and vanadium) and mixtures of platinum group compounds and non-platinum group compounds may also be used for protecting stainless steel surfaces in reactors. U.S. Pat. No. 5,818,893 mentions that the compounds may be organometallic, organic or inorganic and may be soluble or insoluble in water. All of the experimental examples in U.S. Pat. No. 5,818,893 involve dissolving palladium acetylacetonate into an ethanol/water mixture to form a solution for injection.

Sodium hexahydroxyplatinate Na₂Pt(OH)₆ is currently provided by GE-Hitachi Nuclear Energy for addition to the reactor water of BWR plants as the OLNC chemical additive. As such, when used in reactors having zirconium fuel cladding, the sodium will come in contact with the zirconium fuel cladding. OLNC additions are planned to occur once per year. If platinum compounds are used for applications protecting the metallic structures of the reactor against IGSCC or for other reasons, then through decomposition in the reactor water conditions or through those existing on the deposits accumulated in operation on zirconium fuel rods, the platinum separates from the rest of the compound and proceeds to localize itself as intended on the metallic structures to be protected against IGSCC or inside the deposition existing on top of fuel rods.

### SUMMARY OF THE INVENTION

The prevent invention involves injecting platinate compounds in a manner that minimizes caustic formations in deposits formed on fuel rods part of the fuel assemblies installed inside the nuclear reactor core.

A method of injecting platinum into a Boiling Water Reactor is provided. The Boiling Water Reactor includes a reactor core including a plurality of fuel rods having a zirconium alloy cladding. The method includes injecting a first platinate compound and a second platinate compound into a nuclear reactor. The first platinate compound is non-alkalizing and the second platinate compound includes an alkalizing element. The first platinate compound and the second platinate compound are injected such that the second platinate compound injected does not exceed a predetermined threshold or such that a value related to an alkalizing element of the second platinate compound does not exceed a predetermined threshold.

Another method of injecting platinum into a Boiling Water Reactor is also provided. The method includes injecting a first platinate compound and a second platinate compound into a nuclear reactor. The first platinate compound is formed of elements being selected from the group consisting of (1) platinum, hydrogen and oxygen, (2) platinum, hydrogen, oxygen and carbon, and (3) platinum, hydrogen, oxygen, carbon and nitrogen. The second platinate compound includes at least one alkalizing element selected from the group consisting of sodium and potassium. The first platinate compound and the second platinate compound are injected such that the second platinate compound injected does not exceed a predetermined threshold or such that a value related to an alkalizing element of the second platinate compound does not exceed a predetermined threshold.

Another further method of injecting platinum into a Boiling Water Reactor is also provided. The method includes performing a deposit modeling simulation for a surface of the cladding of at least one of the fuel rods. The deposit modeling simulation estimates at least one variable related to the cladding of the at least one fuel rod as a function of injection of a platinate compound including alkalizing elements into the reactor feedwater. The method also includes controlling amounts and contents of platinate compounds injected into the Boiling Water Reactor as a function of the estimated at least one variable related to the cladding of the at least one fuel rod.

### BRIEF DESCRIPTION OF THE DRAWINGS

The present invention is described below by reference to the following drawings, in which:

FIG. 1 schematically shows a BWR for platinum injection in accordance with an embodiment of the present invention;

FIG. 2 shows a flow chart illustrating a method of injecting platinum into a BWR in accordance with an embodiment of the present invention; and

FIG. 3 shows an overall statistical analysis for zirconium samples subjected to three different solutions.

### DETAILED DESCRIPTION

A simulation of the deposition on a specific location of a fuel rod in a given Boiling Water Reactor U.S. plant indicates that after 519 days of operation at the given location of the fuel pin the deposit thickness increases from 0 to 114 microns while the temperature at the surface of zirconium fuel rod increases from 288 C to approximately 350 C. An increase of temperature in deposit brings with it an increase in concentration of species. Increases of concentrations of species with three orders of magnitude are very common in deposits on fuel. Minimizing the injection of platinum compounds including alkalizing elements, i.e., elements resulting in elevated localized alkalizing conditions when injected into the boiling bulk fluid, most particularly sodium and potassium, which result in alkalizing compounds such as sodium hydroxide (NaOH) and potassium hydroxide (KOH), advantageously reduces the growth rate of zirconium oxide on the cladding of the fuel rods.

In particular, sodium hexahydroxyplatinate decomposition in the crud deposit existing on the surface of zirconium cladding of nuclear fuel rods in a BWR would result in Pt and NaOH, where the NaOH, the alkalizing compound including the alkalizing element Na, concentrates resulting in increases of two to three orders of magnitude of the concentrations usually existing in reactor water. The concentration of the NaOH at the surface of the zirconium cladding results in caustic conditions poorly tolerated by zirconium. Platinum also accumulates in deposition, next to fuel zirconium material, having a synergistic and catalytic action in decomposing and transforming the rest of compounds concentrated in the deposition pores, including NaOH.

The need to have the zirconium fuel rod wall intact during the reactor operation or eventually during an accident is fundamental to the need of protecting the reactor operation and ultimately the population of unwanted releases of radioactive material through zirconium fuel rod wall failure. Accordingly, there is a need for taking every precaution in operation, including through limiting the injection of platinum compounds that form alkalizing compounds within the reactor core that concentration in deposits on the outer surface of the zirconium cladding. In particular, this may be accomplished by injecting both a first platinate compound, which does not include an alkalizing element, and a second platinate compound, which includes an alkalizing element, into a nuclear reactor such that the second platinate compound injected does not exceed a predetermined threshold or such that a value related to an alkalizing element of the second platinate compound does not exceed a predetermined threshold.

In embodiments of the present invention, the first platinum compounds are non-alkalizing compounds. The non-alkalizing compounds do not include alkalizing elements such as sodium and potassium and only include non-alkalizing elements, i.e., elements not resulting in elevated localized alkalizing conditions when injected into the boiling bulk fluid. In preferred embodiments, the first platinum compounds include only non-alkalizing elements and are formed of elements being selected from the group consisting of (1) platinum, hydrogen and oxygen; (2) platinum, hydrogen, oxygen and carbon; and (3) platinum, hydrogen, oxygen, carbon and nitrogen. Accordingly, the first platinum compounds do not include any elements other than platinum, hydrogen, oxygen, carbon and nitrogen, except for possibly trace amounts of constituents that are not intentionally added for their known effectiveness. In particular, the first platinum compounds may include tetramethylammonium hexahydroxyplatinate (“TMAP”) [(CH₃)₄N]₂[Pt(OH)₆] and methylammonium hexahydroxyplatinate=[(CH₃)NH₃]₂[Pt(OH)₆]. Other of the first platinum compounds may include ammonium platinates or amine platinates.

In embodiments of the present invention, the second platinum compounds, which include alkalizing elements, include at least one of the elements selected from the group consisting of sodium and potassium. In one preferred embodiment, the second platinum compound is sodium hexahydroxyplatinate.

In one embodiment of the present invention, the value related to an alkalizing element of the platinate compound is the concentration of the alkalizing element in the boiling bulk fluid in the BWR reactor core. Accordingly, a platinum compound including an alkalizing element may be injected into the BWR reactor core until the concentration of the alkalizing element in the boiling bulk fluid in the BWR reactor core reaches a predetermined threshold. In a preferred embodiment, sodium hexahydroxyplatinate may be injected into the BWR reactor core until the concentration of sodium in the boiling bulk fluid in the BWR reactor core reaches a predetermined value between 15 ppb to 30 ppb. After the predetermined threshold, for example 15 ppb, is reached, the operator of the BWR only injects one or more non-alkalizing platinum compounds, for example TMAP, such that the predetermined threshold of 15 ppb is not exceeded. Accordingly, this embodiment may include injecting a platinum compound including an alkalizing element into a BWR reactor core, measuring the concentration of the alkalizing element in the bulk fluid of the BWR reactor core, comparing the concentration of the alkalizing element in the bulk fluid to a predetermined threshold, and injecting platinum compounds including only non-alkalizing elements into the BWR reactor core when the concentration of the alkalizing elements in the bulk fluid exceeds the predetermined threshold. Once the predetermined threshold is reached, the injection of the platinum compound including alkalizing elements is prohibited. For example, the steps may include injecting a sodium hexahydroxyplatinate into the BWR reactor core, measuring the concentration of the sodium in the bulk fluid of the BWR reactor core, comparing the concentration of the sodium in the bulk fluid to a predetermined threshold, and injecting TMAP, and not sodium hexahydroxyplatinate or any other platinate compound including an alkalizing element, into the BWR reactor core when the concentration of the alkalizing elements in the bulk fluid exceeds the predetermined threshold. In the time period after the predetermined threshold is reached, injection of sodium hexahydroxyplatinate or any other platinate compound including an alkalizing element is ceased.

In another embodiment, the injection of platinum compounds is controlled based on calculations of BWR Crud modeling software for modeling the deposition on a unit surface as a function of time based on changing thermalhydraulic and chemistry conditions. The modeling software may incorporate a realistic distribution in the deposit of a sponge-like crud layer in continuous transformation over time. A chemistry engine of the modeling software may for example be powered by OLI Systems, Inc., a commercial computer software package (and associated databases) that simulates aqueous-based chemical systems, and may employ a predictive thermodynamic framework for calculating the physical and chemical properties of multi-phase, aqueous based systems. The amounts and contents of platinate compounds injected into the reactor core may be a function of an estimated at least one variable related to the cladding of the at least one fuel rod based on a predetermined time period, such as an expected exposure period to a reactor pressure vessel water environment in a reactor pressure vessel (i.e., an estimated length of time each rod is usable in a nuclear reactor to at least partially drive nuclear fission).

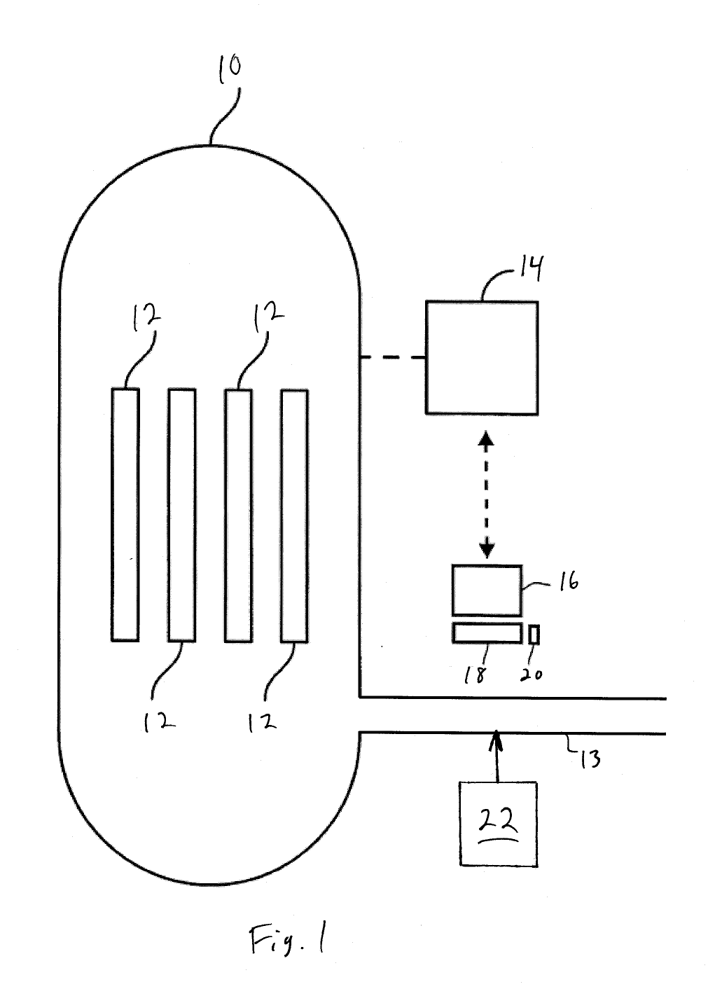

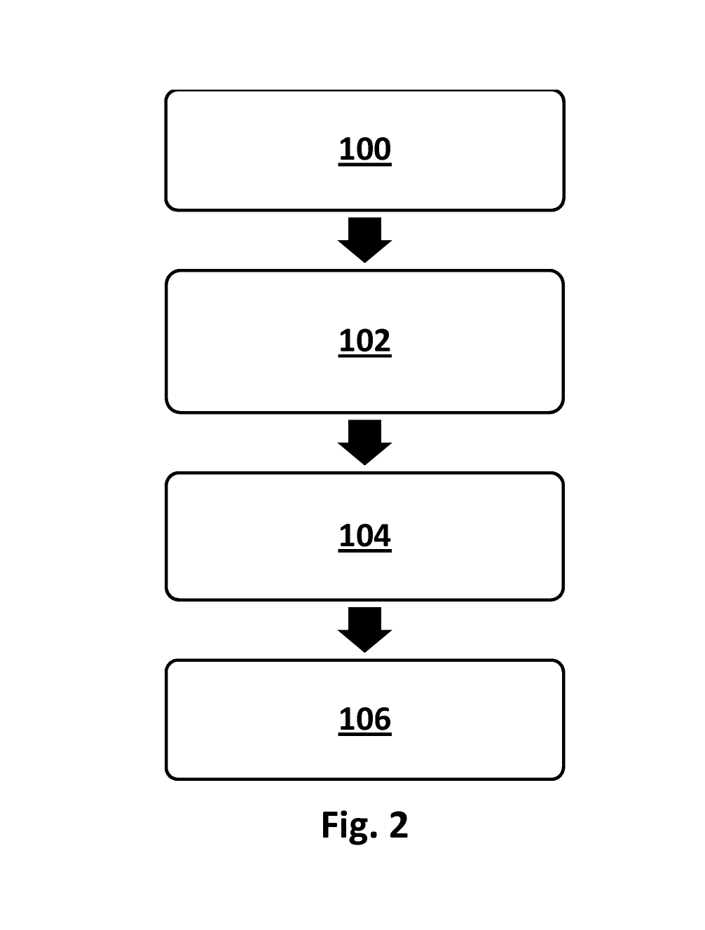

FIG. 1 shows schematically shows a BWR pressure vessel 10 for platinum injection in accordance with an embodiment of the present invention. BWR pressure vessel 10 includes a plurality of schematically shown fuel rods 12 in its core. Feedwater is provided to the reactor core via a feedwater line 13. A controller 14 is provided for operating BWR pressure vessel 10 in accordance with a non-transitory computer readable media programmed or structured to define modules having logic for performing the steps described with respect to the method described below with respect to FIG. 2. The non-transitory computer readable media includes computer executable process steps operable to control controller 14 in accordance with the method described with respect to FIG. 2.

Controller 14 may be in wired or wireless communication with a display device 16 and at least one user input device, for example a keyboard 18 and a mouse 20. Display device 16 may also be a touchscreen display that may be used as an additional or alternative user input device. Display device 16 may display graphic user interfaces illustrating the values used in the method to the user and allowing the user to alter the values. The user may input various values for amounts of the first platinate compound PC1, which do not include alkalizing elements, and for amounts of second platinate compound PC2, which include alkalizing elements, to model the evolution of the deposit layers on the zirconium fuel rod cladding over time. In one embodiment, the user may initiate a simulation of injection of the first platinate compound and the second platinate compound together over a two week period once a year for the expected exposure period to a reactor pressure vessel water environment of the fuel rod or fuel rods most likely to experience cladding failure. For example, the user may input specific platinum injection values for the first platinate compound injection PC1 (e.g., PC1=3 micrograms/square cm of fuel pin area) and specific values for the second platinate compound injection PC2 (e.g., PC2=7 micrograms/square cm of fuel pin area), or total amount of the injection of the combination of the first and second platinate compound may be set, and the user may simply input percentages (e.g., 30% PC1 and 70% PC2) or a ratio for the injection (e.g., 2 parts PC1 to 3 parts PC2[2PC1:3PC2]).

The platinum injection values PC1 and PC2 are then applied by the modeling software to mathematical representations stored on the computer readable medium for modeling the predicted growth of the deposit layer based on, for example, numeral values in the form of parameters of BWR pressure vessel 10, actual deposit samples taken from the cladding of one of fuel rods 12 and/or historical operating parameters of similar BWRs. These mathematical representations may include values representing thermalhydraulic and chemistry parameters affecting deposit layers, for example including values for compositions of solid species in deposit layers, temperature profiles of deposit layers, chemical equilibrium conditions of deposit layers, mass balances of solid species in deposit layer and geometries deposit layers. The modeling software determines when at least one temperature related variable of the cladding of one more of fuel rods 12 is heated to a dangerously high value for the specified platinum injection values PC1 and PC2 (e.g., when the temperature on a hottest point of the cladding of a hottest nuclear fuel rod reaches a predetermined value). As used herein, temperature related variable of the cladding includes the temperature of the cladding or any variable that is dependent on the temperature and thus may be considered an indirect measure of the temperature of the cladding. For example, the thermal expansion of the cladding material is an indirect measure of the temperature of the cladding and is a temperature related variable.

Increased buildup of the actual deposition on the heat transfer surface affects the ability of the coolant fluid to cool the cladding outer surface of fuel rods 12 and the quantity of platinum that is accumulated on fuel rods 12. The higher the deposition on a fuel rod, the higher the quantity of Pt that is accumulated both in the deposition and in the zirconium oxide that forms on the surface of fuel pin. Higher values of platinum accumulated in deposits result in higher oxide formation rates, which ultimately increase the maximum temperature the deposition reaches, when considering only the effect of deposition on temperature increase. If the temperature related variable of the cladding of one more of fuel rods 12 reaches a predetermined limit during the expected exposure period to a reactor pressure vessel water environment of the fuel rod or fuel rods 12 most likely to experience cladding failure, the specified platinum injection values PC1 and PC2 are inappropriate and need to be adjusted. If the temperature related variable of the cladding of one more of fuel rods 12 reaches a predetermined limit during the expected exposure period to a reactor pressure vessel water environment of the fuel rod or fuel rods most likely to experience cladding failure, the amount of the second platinate compound PC2 injected is then decreased. The amount of the first platinate compound PC1 injected may be increased an amount corresponding to the decrease of the amount of the second platinate compound PC2 injected. The modeling software may then run another simulation with the new platinum injections values to determine if the temperature related variable of the cladding of one more of fuel rods 12 reaches a predetermined limit during the expected exposure period to a reactor pressure vessel water environment of the fuel rod or fuel rods most likely to experience cladding failure. Numerous simulations may be run to determine a threshold value for the second platinate compound PC2. For example, the threshold may be a specific value for the second platinate compound injection PC2 (e.g., PC2=3 micrograms/square cm of fuel pin area). The first platinate compound and second platinate compound may then be injected into the core of BWR pressure vessel 10 such that the amount of second platinate compound injected does not exceed the predetermined threshold. In one preferred embodiment, in order to maximize the injection amount of for example sodium hexahydroxyplatinate, which is generally rather accessible, and to minimize the injection amount of for example TMAP, which is generally less accessible, the injection amount of sodium hexahydroxyplatinate is set at as close to the predetermined threshold as possible. At least one pump 22 may be provided for injecting the platinate compounds into the reactor. The first platinate compound and second platinate compound may be injected simultaneously or consecutively. Separate pumps 22 may be provided for the first platinate compound and second platinate compound or the first platinate compound and second platinate compound may be injected by a single pump 22.

In another embodiment, instead of the modeling software performing a simulation for each injection or injections at each BWR, the values from the simulations may be used as a base line for probabilistically determining injections values for further injections.

FIG. 2 shows a flow chart illustrating a method of injecting platinum into a Boiling Water Reactor in accordance with a first embodiment of the present invention. In a step 100, a total amount of platinum to be injected into the reactor feedwater is determined. The total amount of platinum to be injected may be consistent with conventional values. For example, total amount of platinum may be based on injection rates of varying the percentage of the quantities injected between 1 to 99% of any of the two compounds.

In a step 102, a threshold for injecting platinate compounds including alkalizing elements is determined. As discussed above, the threshold may be established for example based on at least one variable related to the cladding of the at least one fuel rod during a predetermined time period. The at least one variable related to the cladding of the at least one fuel rod may be at least one temperature related variable of the cladding of the at least one fuel rod, a heat flux between the cladding of the at least one fuel rod and the coolant in the reactor core, or an acceptable growth rate of deposits on the cladding of the at least one fuel rod.

In a step 104, the amounts of the first platinate compound PC1, which do not include alkalizing elements, and for amounts of second platinate compound PC2, which include alkalizing elements, are determined based on the predetermined threshold from step 102. In one embodiment, the injection amount of the second platinate compound PC2 may be set as close to the predetermined threshold as possible. In another embodiment, the injection amount of the second platinate compound PC2 may be set at a percentage of the predetermined threshold, for example 50% to 90% of the predetermined threshold. The injection amount of the first platinate compound PC1 may then be determined based on the total injection amount of platinum and the injection amount of the second platinate compound PC2.

In a step 106, the first platinate compound and the second platinate compound may injected into the reactor feedwater in the amounts PC1 and PC2 established in step 104. The first platinate compound and the second platinate compound may be injected into reactor water in various ways including as nanoparticles or nanofluids. The injection of both the first platinate compounds and the second platinate compounds allows for a decrease in the amount of alkalizing compounds as compared to conventional platinum injection methodologies without decreasing the total amount of platinum injected.

For a next platinum injection, for example approximately one year from the most recent platinum injection, steps 100 to 106 may be repeated or the platinum injection may be injected in the same quantities as the most recent platinum injection. In one embodiment, the modeling software may run another simulation based on changed conditions within the reactor core to determine the threshold for injecting platinate compounds including alkalizing elements. Accordingly, the threshold for injecting platinate compounds including alkalizing elements may vary from one injection to the next and the amount of the first platinate compound PC1 and the second platinate compound PC2, and the ratio of PC1 to PC2, may vary from one injection to the next.

In other embodiments of the present invention, more than two platinum compounds may be injected into the reactor. For example, two platinum compounds including alkalizing elements may be injected and one platinum compound not including alkalizing elements may be injected. In such embodiments, an injection threshold may be determined for each platinum compound including alkalizing elements separately.

The increased degradation of the zirconium surface of fuel rod cladding caused by the injection of platinum compounds including alkalizing elements was illustrated by a series of tests performed on a number of Zircaloy-2 un-oxidized coupons subjected in two different autoclaves at conditions enveloping BWR operating conditions in crud for four months. The solutions in each autoclave contained the same molar quantities of platinum as sodium hexahydroxyplatinate in a first autoclave (“Autoclave 1”) and as TMAP in a second autoclave (“Autoclave 2”).

In addition to the autoclave testing with the Zircaloy-2 cladding material, TMAP was also evaluated in the presence of UV radiation to address concerns regarding the radiolytic decomposition of this material, resulting in no chemicals detrimental to reactor materials.

It is known that in BWR plants, a fuel deposit produces concentration of species of 1,000-10,000 based on extensive experience with BWR fuel deposits. A concentration factor of 3,500 for species used in the experiments was considered appropriate. For example, the test conditions were maintained in the autoclave at a temperature of 550° F. and a pressure saturation of ˜1044 psia. The initial conditions included an oxygen concentration of ˜200 ppb, a hydrogen concentration of 0.2 ppm and a saturated nitrogen concentration.

At the end of four months of testing, SEM images of the fuel cladding specimens exposed in autoclave at BWR parameters in the chemistry testing regimens (Na₂Pt(OH)₆ and TMAP) were examined to characterize and compare the severity of any specimen oxide degradation experienced. Images included both surface images zirconium oxide surfaces and cross section images of oxide formed following exposure of zirconium pin material to each of the chemistry regimens. The images included scales of 1 or 2 micrometers. To study the effect of various regimens on zirconium fuel pin surface, a Crack Area Factor (CAF) was defined. CAF values were determined by multiplying the number of cracks observed with their length and width for each given sample SEM image surface and then dividing it to SEM surface and multiplying it by 100.

An image of the surface from Autoclave 1 exposed four months to Na₂Pt(OH)₆, identified 12 identified cracks on Zircaloy-2 material with an average length of 3.920 microns and an average width of 0.120 microns. The lengths and widths of the cracks are a measure of the severity of surface degradation. The product of the average of all cracks length and average of all cracks width is 0.470 microns squared, which multiplied with the number of cracks results in 5.645 square microns. This number, divided by the surface of the analyzed area of the image and multiplied with 100 gives a unitless CAF of 1.604.

An image of the surface from Autoclave 2 exposed four months to TMAP has 27 identified cracks with an average length of 2.564 microns and an average width of 0.045 microns. The lengths and widths of the cracks are a measure of the severity of surface degradation. The product of the average crack length and average crack width with the number of cracks is 0.098 square microns and when divided by the analyzed area of the image and multiplied with 100 gives a unitless CAF of 0.880.

As previously discussed, the Crack Area Factor (CAF) values were determined by multiplying the number of cracks observed with their length and width for each given sample SEM image surface and then dividing it to SEM surface and multiplying it by 100. The overall statistical analysis, based on the average crack lengths and widths from Na₂Pt(OH)₆ exposed and TMAP exposed set of samples is presented in Table 2.

TABLE 1
Statistical Characterization of Crack Population
(CAF) from Each Set of Samples

| | | Average | Standard |
|---|---|---|---|
| Autoclave | Solution | CAF | Deviation |
| 1 | Na₂Pt(OH)₆ | 1.351 | 0.3102 |
| 2 | TMAP | 0.598 | 0.2931 |

The average values obtained may be interpreted as the percentage that the cracks represent of the whole SEM surface area analyzed, knowing that the cracks are formed in the depth of the material the SEM surface covers.

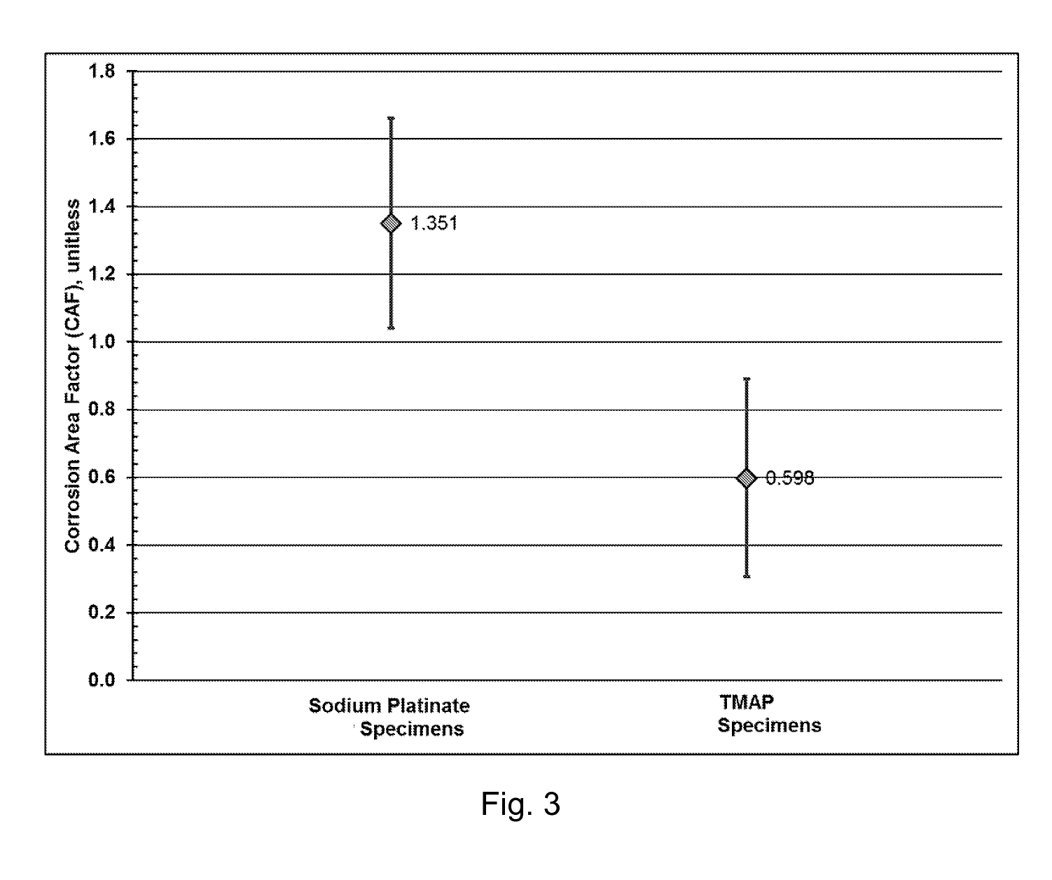

The overall statistical analysis for each of the two populations (Na₂Pt(OH)₆ and TMAP) is presented in Table 2 and in FIG. 3. Provided are the averages and standard deviations of CAF. The values in Table 2 indicate that, at an equivalent molar quantities (either platinum or sodium), the Na₂Pt(OH)₆ is much aggressive towards cracking of the Zircaloy-2 material than the platinate compound (TMAP) not including any element resulting in elevated localized alkalizing conditions.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method of injecting platinum into a Boiling Water Reactor, the Boiling Water Reactor including a reactor core including a plurality of fuel rods having a zirconium alloy cladding, the method comprising:
injecting a first platinate compound and a second platinate compound into a nuclear reactor, the first platinate compound being non-alkalizing, the second platinate compound including an alkalizing element, the first platinate compound and the second platinate compound being injected such that the second platinate compound injected does not exceed a predetermined threshold or such that a value related to an alkalizing element of the second platinate compound does not exceed a predetermined threshold.

2. The method as recited in claim 1 wherein the first platinate compound consists essentially of platinum, hydrogen and at least one of carbon, oxygen and nitrogen.

3. The method as recited in claim 2 wherein the first platinate compound consists essentially of platinum, hydrogen, carbon and oxygen.

4. The method as recited in claim 3 wherein the first platinate compound includes hexahydroxyplatinate.

5. The method as recited in claim 4 wherein the first platinate compound includes methylammonium platinate.

6. The method as recited in claim 5 wherein the first platinate compound is tetramethylammonium hexahydroxyplatinate.

7. The method as recited in claim 5 wherein the first platinate compounds are methylammonium hexahydroxyplatinate.

8. The method as recited in claim 2 wherein the first platinate compound consists essentially of platinum, hydrogen and oxygen.

9. The method as recited in claim 1 wherein the alkalizing elements include at least one of sodium and potassium.

10. The method as recited in claim 1 wherein the second platinate compound is sodium hexahydroxyplatinate.

11. The method as recited in claim 1 further comprising determining an approximation of alkalizing compounds at a surface of at least one of the fuel rods having a greatest thickness of deposits, adjusting the predetermined threshold as a function of the approximation of the alkalizing compounds.

12. The method as recited in claim 1 wherein the ratio of the first platinate compound to the second platinate compound is between 1:100 and 100:1.

13. The method as recited in claim 1 wherein the predetermined threshold is a concentration of between 15 to 30 ppb of the alkalizing element in bulk fluid in the reactor core.

14. A method of injecting platinum into a Boiling Water Reactor, the Boiling Water Reactor including a reactor core including a plurality of fuel rods having a zirconium alloy cladding, the method comprising:
injecting a first platinate compound and a second platinate compound into a nuclear reactor,
the first platinate compound formed of elements being selected from the group consisting of:
platinum, hydrogen and oxygen,
platinum, hydrogen, oxygen and carbon, and
platinum, hydrogen, oxygen, carbon and nitrogen,
the second platinate compound including at least one alkalizing element selected from the group consisting of sodium and potassium,
the first platinate compound and the second platinate compound being injected such that the second platinate compound injected does not exceed a predetermined threshold or such that a value related to an alkalizing element of the second platinate compound does not exceed a predetermined threshold.

15. The method as recited in claim 14 wherein the second platinate compound includes sodium hexahydroxyplatinate.

16. A method of injecting platinum into a Boiling Water Reactor, the Boiling Water Reactor including a reactor core including a plurality of fuel rods having a zirconium alloy cladding, the method comprising:
performing a deposit modeling simulation for a surface of the cladding of at least one of the fuel rods, the deposit modeling simulation estimating at least one variable related to the cladding of the at least one fuel rod as a function of injection of a platinate compound including alkalizing elements into the reactor feedwater; and
controlling amounts and contents of platinate compounds injected into the Boiling Water Reactor as a function of the estimated at least one variable related to the cladding of the at least one fuel rod.

17. The method as recited in claim 16 wherein the controlling includes injecting platinate compounds formed of elements being selected from the group consisting of:
platinum, hydrogen and oxygen,
platinum, hydrogen, oxygen and carbon, and
platinum, hydrogen, oxygen, carbon and nitrogen.

18. The method as recited in claim 16 wherein the alkalizing elements include sodium and potassium.

19. The method as recited in claim 18 wherein the controlling includes limiting injection of sodium hexahydroxyplatinate.

20. The method as recited in claim 16 wherein the controlling includes controlling the amounts and contents of platinate compounds injected into the Boiling Water Reactor such that the estimated at least one variable related to the cladding of the at least one fuel rod does not reach a predetermined value during a predetermined time period.

21. The method as recited in claim 20 wherein the predetermined time period is an expected operational life of the at least one fuel rod.
